(19) United States
(12) Patent Application Publication
(10) Pub. No.: US 2020/0372838 A1
(43) Pub. Date: Nov. 26, 2020

(54) REVO LENS DRIFT STICKERS

(71) Applicant: Shour Sheng Enterprise Co., Ltd., Tainan City (TW)

(72) Inventor: Kuo-Tsai Wang, Tainan City (TW)

(21) Appl. No.: 16/590,310

(22) Filed: Oct. 1, 2019

(30) Foreign Application Priority Data
May 23, 2019 (TW) 108206459

(51) Int. Cl. G09F 3/02; G09F 19/14; C09J 7/21

(52) U.S. Cl. CPC G09F 3/02; G09F 19/14; G09F 3/04; G09F 2003/0257; C09J 7/21

(57) ABSTRACT

This invention provides a revo lens drift sticker, which is formed from the sequential disposition of one backing paper, one adhesive layer, one colored ink layer, one transparent UV resin layer, one multi-layer coating, one UV curing ink and one transfer affixation film. At the time of use, the sticker is first soaked in water to cause it to separate from the backing paper, the sticker layer is fit on the surface of an object using the adhesive layer, and the sticker is baked to cause the adhesive layer, the colored ink layer, the transparent UV resin layer, the multi-layer coating, and the transparent gold oil protective layer to be thermally cured, which will allow the transfer affixation film to be peeled off, completing sticker affixation. The revolution lens drift sticker provided in this invention takes advantage of the foregoing multi-layer coating to give rise to different indices of refraction through optical interference, which will cause the colored pattern or text of the colored ink layer to display multilayered color changes under different viewing angles and changes in the brightness of illumination. This can provide the effect of varied color changes, therefore, and make the visual effect of stickers and goods livelier and more beautiful.

### CROSS-REFERENCE TO RELATED APPLICATION

This application claims priority to Taiwanese patent application No. 108206459, filed on May 23, 2019, entitled “Revo Lens Drift Stickers”, the content of which is hereby incorporated by reference in its entirety.

### FIELD OF THE INVENTION

This invention relates to a type of aqueous transfer printing color sticker, and especially relates to a revolution drift sticker in which the visual effect caused by a reinforced colored ink layer can generate different indices of refraction through the principle of optical interference, and cause the colored ink layer to display multilayered color changes, which effectively enhances the vibrancy and beauty of the colored ink layer's visual effect.

### DESCRIPTION OF RELATED ART

Existing aqueous transfer printing color stickers are formed from the sequential disposition of one backing paper, one adhesive layer, one colored ink layer, and one transfer affixation film; at the time of use, the sticker is first soaked in water to cause it to separate from the backing paper, and the sticker layer is fit on the surface of an object using the adhesive layer. The transfer affixation film is removed after the sticker has dried, which leaves the colored ink layer affixed to the object's surface, and the colored ink layer forms an attractive decorative pattern or text. However, existing aqueous transfer printing color stickers possess only an ordinary planar visual effect consisting of a pattern or text, which will tend to be monotonous and stiff, and will cause the imaging effect to lack liveliness and beautiful aesthetics. This will lead to the loss of market competitiveness and product added value.

### SUMMARY OF THE INVENTION

In order to resolve the problem that existing aqueous transfer printing color stickers possess only an ordinary planar visual effect and are therefore excessively monotonous and stiff, this invention provides a type of revolution drift sticker, in which a multi-layer coating is disposed on top of the colored ink layer, where the multi-layer coating can generate different indices of refraction through the principle of optical interference, which causes the colored pattern or text of the colored ink layer to display multilayered color changes under different viewing angles and changes in the brightness of illumination. This can provide the effect of varied color changes, and make the visual effect of stickers and goods livelier and more beautiful.

This invention provides a type of revo lens drift sticker, which is formed from the sequential disposition of a backing paper, an adhesive layer, a colored ink layer, a transparent UV resin layer, a multi-layer coating, a UV curing ink and a transfer affixation film. At the time of use, the sticker is first soaked in water to cause it to separate from the backing paper, the sticker layer is fit on the surface of an object using the adhesive layer, and the sticker is baked to cause the adhesive layer, the colored ink layer, the transparent UV resin layer, the multi-layer coating, and the transparent gold oil protective layer to be thermally cured, which will allow the transfer affixation film to be peeled off, completing sticker affixation.

The revolution lens drift sticker provided in this invention takes advantage of the foregoing multi-layer coating to give rise to different indices of refraction through optical interference, which will cause the colored pattern or text of the colored ink layer to display multilayered color changes under different viewing angles and changes in the brightness of illumination. This can provide the effect of varied color changes, and make the visual effect of stickers and goods livelier and more beautiful.

The aforementioned transparent UV resin layer has a protective effect that serves to stabilize the colored pattern or text on the colored ink layer.

The aforementioned transparent UV resin layer may be a transparent gold oil layer.

The aforementioned transparent gold oil protective layer has a protective effect that serves to stabilize the multi-layer coating.

### BRIEF DESCRIPTION OF THE DRAWINGS

FIG. 1 is a cross-sectional view of a revo lens drift sticker according to an embodiment of this invention.

FIG. 2 illustrates cross-sectional views of a revo lens drift sticker according to an embodiment of this invention, showing the procedures of applying the sticker on an object.

### DETAILED DESCRIPTION OF THE PREFERRED EMBODIMENTS

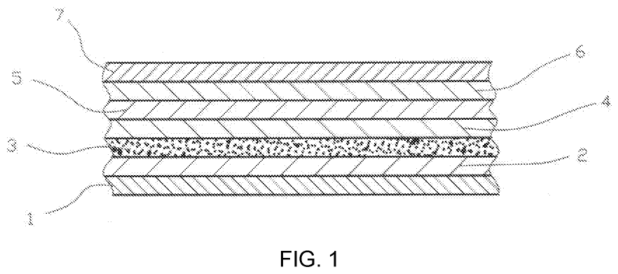

Referring to FIG. 1, this embodiment provides a type of revo lens drift sticker, which includes the sequential disposition of one backing paper (1), one adhesive layer (2), one colored ink layer (3), one transparent UV resin layer (4), one multi-layer coating (5), one UV curing ink (6) and one transfer affixation film (7).

Backing paper (1) comprises a removable planar sheet.

Adhesive layer (2), comprises UV resin, and is disposed on backing paper (1).

Colored ink layer (3) comprises a colored pattern or text printed on adhesive layer (2).

Transparent UV resin layer (4) is disposed on colored ink layer (3) by means of printing, coating, or cladding, and provides a protective effect serving to stabilize the colored pattern or text on colored ink layer (3); the transparent UV resin layer (4) may also be a transparent gold oil layer.

The multi-layer coating (5) is overlaid on transparent UV resin(4), where said multi-layer coating (5) comprises multiple inorganic material layers with different indices of refraction plated together; it possesses an optical interference function, and can cause the color to undergo a wide variety of color changes.

Transparent gold oil protective layer (6) is disposed on multi-layer coating (5) by means of printing, coating, or cladding, and has a protective effect serving to stabilize multi-layer coating (5). The transfer affixation film (7) is removably disposed on transparent gold oil protective layer (6).

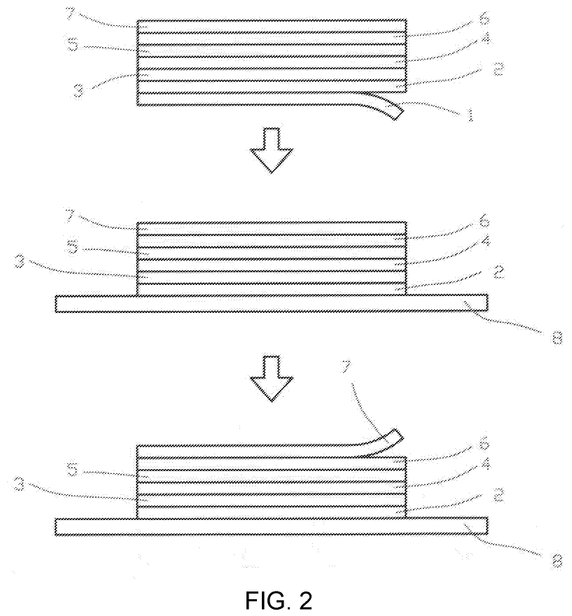

When this invention is embodied and used, referring to FIG. 2, the sticker is first soaked in water to cause backing paper (1) to separate, the sticker layer is fit on the surface of object (8) using adhesive layer (2), and the sticker is baked to cause the adhesive layer (2) to soften and adhere, which will also cause adhesive layer (2), colored ink layer (3), transparent UV resin layer (4), multi-layer coating (5), and transparent gold oil protective layer (6) to be thermally cured, and the removal of transfer affixation film (7) will complete the affixation of the sticker.

Relying on the aforementioned technical characteristics, when the revo lens drift sticker in this invention is affixed to the surface of object (8), the disposition of multi-layer coating (5) will cause the colored pattern or text of the colored ink layer (3) to display multilayered color changes under different viewing angles and changes in the brightness of illumination. This can provide the effect of varied color changes, and make the visual effect of the sticker and object (8) livelier and more beautiful, enhancing its market competitiveness and product added-value.

What is claimed is:

1. A revo lens drift sticker, comprising:
a backing paper including a removable planar sheet;
an adhesive layer disposed on top of the backing paper;
a colored ink layer forming colored pattern or text printed on the adhesive layer;
a multi-layer coating disposed on top of the colored ink layer; and
a transfer affixation film removably disposed on top of the multi-layer coating;
wherein the multi-layer coating comprises multiple inorganic material layers of with different indices of refraction plated together, which causes the colored pattern or text of the colored ink layer to display multilayered color changes under different viewing angles and changes in brightness of illumination.

2. The revo lens drift sticker of claim 1, wherein a transparent UV resin layer is disposed between the colored ink layer and the multi-layer coating, the transparent UV resin layer has a protective effect serving to stabilize the colored ink layer, and allows overlay of the multi-layer coating.

3. The revo lens drift sticker of claim 1, wherein a transparent gold oil protective layer is disposed between the multi-layer coating and the transfer affixation film, the transparent gold oil protective layer has a protective effect serving to stabilize the multi-layer coating.

4. The revo lens drift sticker of claim 2, wherein the transparent UV resin layer comprises a transparent gold oil layer.
